(19) United States
(12) Patent Application Publication
(10) Pub. No.: US 2026/0181464 A1
(43) Pub. Date: Jun. 25, 2026

(54) TIMING ADVANCE REPORTING METHOD AND APPARATUS

(71) Applicant: CHINA SATELLITE NETWORK INNOVATION CO., LTD, Beijing (CN)

(72) Inventors: Gaojian WANG, Beijing (CN); Ge MANG, Beijing (CN); Dongqing QI, Beijing (CN); Lu ZHANG, Beijing (CN); Dongjun MA, Beijing (CN); Niwei WANG, Beijing (CN); Yang ZHANG, Beijing (CN)

(21) Appl. No.: 19/541,370

(22) Filed: Feb. 16, 2026

Related U.S. Application Data
(63) Continuation of application No. PCT/CN2025/117301, filed on Aug. 27, 2025.

(30) Foreign Application Priority Data
Dec. 5, 2024 (CN) 202411777395.6

(51) Int. Cl. H04W 24/10

(52) U.S. Cl. CPC H04W 24/10

(57) ABSTRACT

The present application relates to the technical field of non-terrestrial network communications, and provides a timing advance reporting method and apparatus. The terminal device generates an information unit according to an estimated timing advance amount and transmits the information unit to a non-terrestrial network device, wherein the information unit includes a first feature field including data of a first dimension and a second feature field including data of a second dimension. The present application improves the reporting accuracy of the timing advance amount by determining data of different dimensions according to the timing advance amount, thereby satisfying the optimization design requirements of the non-terrestrial network device.

### CROSS-REFERENCE TO RELATED APPLICATIONS

This application is a continuation of International Patent Application No. PCT/CN2025/117301 filed on Aug. 27, 2025, which claims the benefits of the Chinese Patent Application No. 202411777395.6, filed on Dec. 5, 2024, and entitled “TIMING ADVANCE REPORTING METHOD AND APPARATUS”, both of which are hereby incorporated by reference in their entireties.

### TECHNICAL FIELD

The present application relates to the technical field of non-terrestrial network communications, and in particular to a timing advance reporting method and apparatus.

### BACKGROUND

When communicating in a terrestrial network, a network device transmits a timing advance amount to a terminal device (UE) through a Timing Advance Command (TAC) MAC CE, so that the terminal device adjusts an uplink transmission time based on the Timing Advance (TA) amount during uplink transmission. In a Non-Terrestrial Network (NTN), the propagation delay between the terminal device and the network device is much longer, ranging from several milliseconds to hundreds of milliseconds, depending on the altitude of the satellite-borne or airborne platform and the type of the payload in the NTN. Therefore, for NTN systems, 3GPP Rel-17/18 modified the timing design of NR (New Radio) from the physical layer to higher layers, including the timing advance mechanism, to handle such long propagation delays.

In order to achieve synchronization during the initial access process and in the connected state, the UE calculates the Round Trip Time (RTT) of the service link based on its own location information (obtained based on the Global Navigation Satellite System (GNSS)) and satellite ephemeris information, and autonomously pre-compensates the timing advance TA. If the UE does not have valid GNSS location information and valid satellite ephemeris information, the UE cannot initiate random access and thus communicate with the network device until both the GNSS location information and the satellite ephemeris information are reacquired. In NTN, it is defined that the UE performs timing advance TA reporting through a Timing Advance Report MAC CE, allowing the network side to obtain the timing advance amount to guide subsequent uplink scheduling optimization, etc.

In 5G NTN, the network device indicates to the terminal device whether timing advance reporting is required through the parameter ta-Report. The terminal device reports the timing advance amount through the Timing Advance Report MAC CE. The network side refers to the reported timing advance amount to schedule uplink transmission resources for the terminal. Therefore, in the prior art, the unit of the reported timing advance amount is the slot length, and such accuracy of timing advance amount cannot meet the optimization design requirements of the network devices.

### SUMMARY

The present application is directed to solve the problem in the prior art that the reporting of the timing advance amount has low accuracy and cannot satisfy the optimization design requirements of non-terrestrial network devices.

In order to solve the technical problem, a first aspect of the present application provides a timing advance reporting apparatus for a terminal device including:
a processing module configured to generate an information unit according to a timing advance amount estimated by the terminal device, wherein the information unit includes a first feature field including data of a first dimension and a second feature field including data of a second dimension; and
a transmitting module configured to transmit the information unit to a non-terrestrial network device.

A second aspect of the present application also provides a timing advance reporting method for a terminal device, including:
generating an information unit according to a timing advance amount estimated by the terminal device, wherein the information unit includes a first feature field including data of a first dimension and a second feature field including data of a second dimension; and
transmitting the information unit to a non-terrestrial network device.

A third aspect of the present application also provides a timing advance reporting apparatus for a non-terrestrial network device, including:
a receiving module configured to receive an information unit transmitted by a terminal device, wherein the information unit includes a first feature field including data of a first dimension and a second feature field including data of a second dimension, and the data of the first dimension and the data of the second dimension are used to determine a timing advance amount estimated by the terminal device.

A fourth aspect of the present application also provides a timing advance reporting method for a non-terrestrial network device, including:
receiving an information unit transmitted by a terminal device, wherein the information unit includes a first feature field including data of a first dimension and a second feature field including data of a second dimension, and the data of the first dimension and the data of the second dimension are used to determine a timing advance amount estimated by the terminal device.

A fifth aspect of the present application also provides a communication system, including: a terminal device and a non-terrestrial network device;
wherein the terminal device is configured to generate an information unit according to an estimated timing advance amount, wherein the information unit includes a first feature field including data of a first dimension and a second feature field including data of a second dimension; and transmit the information unit to the non-terrestrial network device, and
the non-terrestrial network device is configured to receive the information unit.

The timing advance reporting method and apparatus provided by the present application, by generating an information unit according to a timing advance amount estimated by a terminal device, wherein the information unit includes a first feature field including data of a first dimension, and a second feature field including data of a second dimension; and transmitting the information unit to a non-terrestrial network device, can achieve timing advance enhancement and improve the reporting accuracy of the timing advance amount.

To make the above and other objectives, features, and advantages of the present application more comprehensible, preferred embodiments are described below in detail with reference to the accompanying drawings.

### BRIEF DESCRIPTION OF DRAWINGS

In order to more clearly describe the technical solutions in the embodiments of the present application or the prior art, the drawings required to be used in the description of the embodiments or the prior art are briefly introduced below. Obviously, the drawings in the following description are only some embodiments of the present application. For those skilled in the art, other drawings can also be obtained from these drawings without creative efforts.

FIG. 1 is a data structural diagram illustrating Timing Advance Report MAC CE in the prior art;

FIG. 2 is a structural diagram illustrating a communication system according to embodiments of the present application;

FIG. 3 is a first data structural diagram illustrating Timing Advance Report MAC CE according to embodiments of the present application;

FIG. 4 is a second data structural diagram illustrating Timing Advance Report MAC CE according to embodiments of the present application;

FIG. 5 is a third data structural diagram illustrating Timing Advance Report MAC CE according to embodiments of the present application;

FIG. 6 is a fourth data structural diagram illustrating Timing Advance Report MAC CE according to embodiments of the present application;

FIG. 7 is a flowchart illustrating a timing advance reporting method on a terminal device side according to embodiments of the present application;

FIG. 8 is a first flowchart illustrating a timing advance reporting method on a non-terrestrial network device side according to embodiments of the present application;

FIG. 9 is a second flowchart illustrating a timing advance reporting method on a non-terrestrial network device side according to embodiments of the present application;

FIG. 10 is a third flowchart illustrating a timing advance reporting method on a non-terrestrial network device side according to embodiments of the present application;

FIG. 11 is a structural diagram illustrating a timing advance reporting apparatus on a terminal device side according to embodiments of the present application;

FIG. 12 is a first structural diagram illustrating a timing advance reporting apparatus on a non-terrestrial network device side according to embodiments of the present application;

FIG. 13 is a second structural diagram illustrating a timing advance reporting apparatus on a non-terrestrial network device side according to embodiments of the present application;

FIG. 14 is a third structural diagram illustrating a timing advance reporting apparatus on a non-terrestrial network device side according to embodiments of the present application; and

FIG. 15 is a structural diagram illustrating a terminal device according to embodiments of the present application.

### DESCRIPTION OF EMBODIMENTS

The technical solutions in the embodiments of the present application will be clearly and completely described below in combination with the drawings in the embodiments of the present application. Obviously, the described embodiments are only a part of the embodiments, other than all the embodiments, of the present application. Based on the embodiments of the present application, all the other embodiments obtained by those skilled in the art without creative efforts fall within the protection scope of the present application.

It should be noted that the terms “first”, “second” in the description and claims and the above drawings of the present application are used to distinguish similar objects, and are not necessarily used to describe a specific order or sequential order. It should be understood that the data so used can be interchanged under appropriate circumstances so that the embodiments of the present application described herein can be implemented in an order other than those illustrated or described herein. In addition, the terms “comprising” and “having” and any variations thereof are intended to cover non-exclusive inclusions. For example, processes, methods, devices, products, or apparatuses that contain a series of steps or units are not necessarily limited to those steps or units that are explicitly listed, however, other steps or units that are not explicitly listed or inherent to these processes, methods, products, or apparatuses may be included.

This specification provides method operation steps in the embodiments or flowcharts, however, more or fewer operation steps may be included based on routine or non-creative efforts. A sequence of steps listed in the embodiments is merely one of many possible execution sequences of steps and does not represent the only execution sequence. In a case where a system or a device product is actually implemented, it may be executed in sequence or in parallel in accordance with the embodiments or the method illustrated in the drawings.

It should be noted that the information involved in the present application (including but not limited to user terminal device information, user personal information, etc.) is information and data authorized by the user or fully authorized by all parties, and acquisition, transmission, storage, use and processing of relevant data comply with the relevant laws, regulations and standards of relevant countries and regions.

It should be noted that some industry-available solutions such as software, assemblies, models may be mentioned and should be regarded to be exemplary in the embodiments of the present application, and are solely intended to demonstrate the feasibility of implementation of the technical solutions of the present application, however, it does not imply that the applicant has already or must have used the solutions. Unless otherwise specified, the network side in the present application refers to the non-terrestrial network device side, the terminal side refers to the terminal device side, the base station end refers to the non-terrestrial network device end, and both the user location information and the terminal location information refer to the terminal device location information.

The terminal device described in the present application is a device with the capability to communicate with a non-terrestrial network device. The non-terrestrial network device includes satellite equipment, high-altitude platform equipment, and other related equipment (e.g., 3GPP devices, IoT NTN devices, NR NTN devices, etc.).

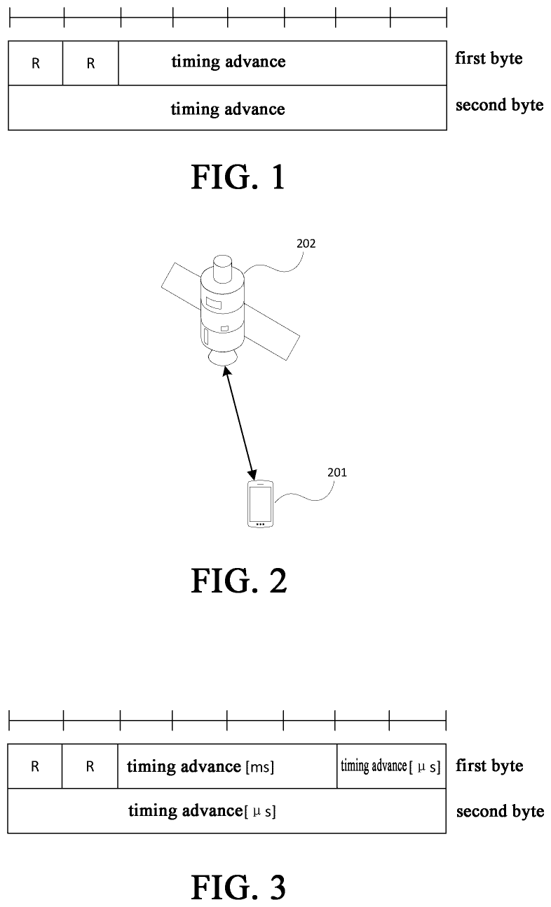

In the 5G NTN, the parameter ta-Report is used to indicate whether the terminal device needs to perform the timing advance report. The terminal device reports the timing advance amount through the Timing Advance Report MAC CE. According to FIG. 6.1.3.56-1 in 38.321, the specific definition of Timing Advance Report MAC CE is as illustrated in FIG. 1. The Timing Advance Report MAC CE contains two bytes, namely, a first byte Oct1 and a second byte Oct2. The first byte Oct1 contains two reserved bits R that are set to zero. The Timing Advance in the first byte Oct1 and the second byte Oct2 is defined, within FRI (frequency range from 450 MHz to 6 GHz), as the smallest integer greater than or equal to the timing advance amount T_{TA}, with the unit being the slot length when the subcarrier spacing is 15 kHz, occupying a total of 14 bits. Therefore, in the prior art, the accuracy of the timing advance report is a slot (a time segment for transmitting data).

In 5G NTN, the network side refers to the reported timing advance amount to schedule uplink transmission resources (frequency resources) for the terminal. In the following scenarios, the network side needs to obtain a higher-accuracy timing advance amount. The timing advance with slot-level accuracy cannot meet the network side's requirements:

Scenario 1: Before obtaining user location information or when the obtained user location information has expired, the network side performs beam pointing optimization based on a precise timing advance amount to improve the performance of users at the edge of the beam footprint. Specifically, when the beam points to the center point of the beam footprint for transmission, the beam gain at the edge of the beam footprint is several dB (units of power gain) worse compared to the center point of the beam footprint.

Scenario 2: Determining that a user terminal device is at the edge of the beam footprint without relying on terminal location information. Specifically, the network side can determine whether the user terminal device is at the edge of the beam footprint based on information such as the precise timing advance amount and beam pointing, thereby optimizing guidance for coverage enhancement, mobility management, etc.

Scenario 3: The GNSS signal of the terminal device is easily interfered with or spoofed. The network side needs a higher-accuracy timing advance amount to improve the robustness of uplink time and frequency synchronization in NTN, to prevent uplink timing misalignment when GNSS is unavailable in connected mode. Of course, it only applies to terminal devices that are already in connected mode when GNSS interference begins.

From the above analysis, it can be seen that the timing advance obtained by the existing network side is in units of slots, and its accuracy cannot meet the requirements for timing advance in the above scenario examples.

In order to solve the technical problem, the embodiments of the present application provide a communication system, as illustrated in FIG. 2, which includes a terminal device 201 and a non-terrestrial network device 202.

The terminal device 201 is configured to generate an information unit according to a timing advance amount, wherein the information unit includes a first feature field including data of a first dimension, and a second feature field including data of a second dimension; and transmit the information unit to the non-terrestrial network device 202. During specific implementation, transmitting the information unit to the non-terrestrial network device 202 includes: first transmitting the information unit to the non-terrestrial network device 202 when the terminal device 201 performs initial random access. For example, transmitting the information unit to the non-terrestrial network device 202 via a Physical Random Access Channel (PRACH) or in a connection request message (msg3).

The non-terrestrial network device 202 is configured to receive the information unit, extract the timing advance amount in the information unit, and perform optimization based on the timing advance amount, such as beam pointing optimization, optimization guidance for coverage enhancement, and mobility management, etc.

By dividing the timing advance amount into data of different dimensions, this embodiment achieves timing advance enhancement and improves the reporting accuracy of the timing advance amount, and thereby supports the system or network side to perform some necessary optimization designs for the terminal device.

The timing advance amount reported by the terminal device 201 is calculated by the terminal device 201. The specific calculation process of the timing advance amount is described below using satellite communication as an example.

In 5G NTN, after completing SIB 19 demodulation and detection, the terminal device can obtain ephemeris information of its satellite (serving satellite). The ephemeris information includes orbital six-element information. Based on the six-element information, the satellite's current accurate position information can be obtained. After obtaining the serving satellite's ephemeris information, the terminal device can extrapolate to obtain ephemeris information at a specific time, such as the transmission time of PRACH, msg3, etc. The terminal device combines the ephemeris information at that time with its own location information to complete the estimation of the distance from the satellite to the terminal device at that time, and then calculates the timing advance amount based on the distance from the satellite to the terminal device at that time.

Currently, in 5G NTN, the timing advance report (TAR) can be carried via Msg3 during the random access process. In addition, event-triggered timing advance reporting is also supported in the connected state.

In NTN, the total timing advance amount on the terminal side is determined in formula (see 38.211):

$${T}_{T A} = ( {N}_{T A} + {N}_{TA , UE - specific} + {N}_{T A , common} + {N}_{T A , offset} ) \times {T}_{c} ;$$

where T_{TA} is the total timing advance amount. T_{C}=0.509 ns is a time unit in NR.

N_{TA} is the timing advance amount indicated by the base station to the terminal device (issued to the terminal device via TAC) by detecting an uplink signal such as a preamble or a Sounding Reference Signal (SRS).

N_{TA,common} is used to compensate for the transmission delay of the link between the satellite (when acting as a relay) and the ground base station, and is configured by a higher-layer parameter.

N_{TA,offset} is determined by the frequency band location for transmitting uplink data on the terminal device side and the duplex mode configuration. For specific parameter values, see Table 7.1.2-2 in 3GPP 38.133.

N_{TA,UE-specific} is the timing advance amount of the link between the terminal device and the satellite estimated by the terminal device based on its own and satellite's location information, and is compensated by the terminal itself.

As can be seen, among the above four parameters, only N_{TA,UE-specific} is an unknown parameter on the network side. To reduce the number of bits occupied by the timing advance report, after receiving the timing advance report indication transmitted by the base station, the terminal device may also report only the timing advance amount estimated by itself, i.e., N_{TA,UE-specific}.

The formula for calculating the timing advance amount in units of T_{c} is as follows:

$${N}_{TA , total} = ( {N}_{T A} + {N}_{TA , UE - specific} + {N}_{T A , common} + {N}_{T A , offset} )$$

If timing advance reporting uses T_{c} as the unit, at least 21 bits are required for the decimal part within 1 ms. Therefore, reporting with T_{c} as the unit for 1 ms accuracy has the problem of requiring a large number of reporting bits.

To save reporting bits while ensuring the distance error is within an acceptable range, the present application proposes the aforementioned solution of dividing the timing advance amount estimated by the terminal device to obtain data of different dimensions and setting the data of different dimensions in different feature fields. Based on this design, the reporting bits can be saved while improving reporting accuracy.

In embodiments of the present application, the accuracy of the first dimension is lower than the accuracy of the second dimension. For example, the first dimension is a millisecond (ms), and the second dimension is a microsecond (μs), thereby providing a larger space for the second dimension and improving the reporting accuracy. In a further embodiment, the information unit is carried in two bytes. In a specific implementation, the first feature field includes at least 4 bits, and the second feature field includes at least 10 bits. For another example, the first dimension is a millisecond (ms), and the second dimension is 1/(15*2048) of a millisecond. In a further embodiment, the information unit is carried in four bytes.

In embodiments of the present application, the first dimension and the second dimension, and the lengths of the first feature field and the second feature field are configured by the non-terrestrial network device. During specific implementation, they may be configured by a communication protocol between the non-terrestrial network device and the terminal device, or may also be dynamically configured by the non-terrestrial network device. For example, when the non-terrestrial network device requires a high-accuracy timing advance amount, it transmits indication information of the first dimension and the second dimension, and the lengths of the first feature field and the second feature field to the terminal device.

In embodiments of the present application, the information unit further includes a parameter field in which indication information is set, and the indication information is used to indicate a data format of a feature field. In detail, the data format includes: a data dimension and a data length.

In some embodiments, the parameter field is configured by the non-terrestrial network device. During specific implementation, the parameter field can be stored in reserved bits in the information unit, such as the first two reserved bits in FIGS. 3 to 6.

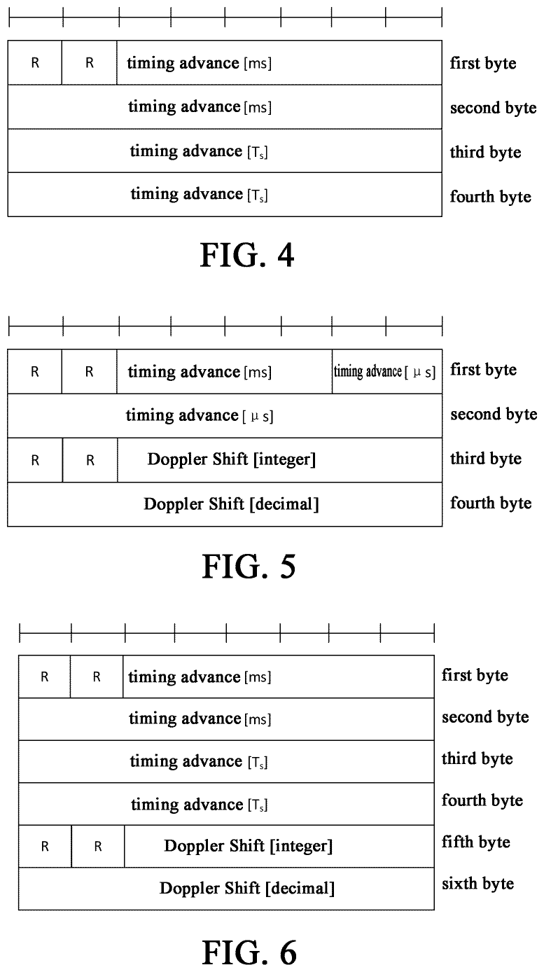

Taking FIG. 3 as an example, the reserved bits RR are the parameter field. When the parameter field is 00, the data format is as shown in FIG. 3, the data length is two bytes, the dimension of the first feature field is a millisecond, and the dimension of the second feature field is a microsecond. When the parameter field is 01, the data format is as shown in FIG. 4, the data length is four bytes, the dimension of the first feature field is a millisecond, and the dimension of the second feature field is T, where Tₛ=64T_{c}, 1 ms=15*2048 Tₛ or 1 ms=15K*2048 Tₛ, 15K is the subcarrier spacing. When the parameter field is 10, the data format is as shown in FIG. 5, the data length is 4 bytes, the first feature field occupies 4 bits, the dimension of the first feature field is a millisecond, the second feature field occupies 14 bits, the dimension of the second feature field is a microsecond, the third feature field occupies 6 bits, the third feature field is integer data of a Doppler frequency shift, the fourth feature field occupies 8 bits, and the fourth feature field is decimal data of the Doppler frequency shift. When the parameter field is 11, the data format is as shown in FIG. 6, the data length is six bytes, the first feature field occupies 14 bits, the dimension of the first feature field is a millisecond, the second feature field occupies 16 bits, the dimension of the second feature field is Ts, the third feature field occupies 6 bits, the third feature field is integer data of a Doppler frequency shift, the fourth feature field occupies 8 bits, and the fourth feature field is decimal data of the Doppler frequency shift.

In embodiments of the present application, the first dimension is a millisecond (ms), the second dimension is a microsecond (μs), and the information unit is transmitted in a two-byte MAC CE format.

The first two bits of the first byte in the MAC CE are reserved bits. The four bits following the reserved bits in the first byte of the MAC CE are used to store the data of the first dimension, and the remaining bits in the MAC CE are used to store the data of the second dimension. The specific format of the MAC CE is as shown in FIG. 3.

In a Low Earth Orbit communication system, the delay from the satellite to the terminal side is generally not greater than 15 ms. That is, 4 bits can represent the data delay in milliseconds, and the remaining 10 bits represent the delay of the remaining data in microseconds, excluding the data portion in milliseconds.

In the solution shown in FIG. 3, the error in transmission distance is about 300 meters. For beams with a radius of about 10 kilometers or larger, the difference in SNR received by terminal devices 300 meters apart is negligible. Compared with the existing TAR, this solution does not require additional bits. However, the representation range of the timing advance TA is limited to within 16 ms, making it suitable for Low Earth Orbit communication systems but unusable for satellite communication systems with higher orbits.

In embodiments of the present application, the first dimension is a millisecond, and the second dimension is a basic time unit Tₛ defined by 3GPP, where Tₛ=64T_{c}, 1 ms=15*2048 Tₛ or 1s=15K*2048 Tₛ, and 15K is the subcarrier spacing. The first feature field at least includes 14 bits, and the second feature field at least includes 16 bits.

During specific implementation, the information unit is transmitted in a four-byte MAC CE format. The first two bits of the first byte in the MAC CE are reserved bits. The remaining bits in the first byte and the second byte in the MAC CE are used to store the data of the first dimension, and the third byte and the fourth byte in the MAC CE are used to store the data of the second dimension.

Specifically, if reporting is performed in units of Tₛ=64T_{c}, the distance error from the satellite to the terminal is controlled to about 10 m. Compared with using T_{c} (which results in a distance error of about 0.15 m), 6 bits can be saved.

N_{TA,UE-specific} is divided into data in milliseconds (ms, where 1 ms=15*2048 Tₛ) and data in units of Tₛ, i.e.:

$${N}_{TA , UE - specific , m s} = mod ( {N}_{TA , UE - specific} , 64 * 15 * 2048 ) ;$$

$${N}_{TA , UE - specific , Ts} = ( {N}_{TA , UE - specific} - {N}_{TA , UE - specific , m s} * 64 * 15 * 2048 ) / 64 ;$$

N_{TA,UE-specific,ms} uses the existing fields (14 bit) of Timing Advance Report MAC CE for reporting, as shown by Oct1 and Oct2 in FIG. 4. N_{TA,UE-specific}, Tₛ needs to be reported by adding two new 8-bit bytes (16 bits) on top of the existing MAC CE field, as shown by Oct3 and Oct4 in FIG. 4.

For the solution in FIG. 4, one may also refer to the method of issuing N_{TA} via the Timing Advance Command (TAC), which is issued in units of 16·64·T_{c}/2^{μ}, i.e., 16·Tₛ/2^{μ}. Taking a subcarrier spacing of 30 kHz as an example, the unit is 8·Tₛ. It can be seen that even if 3 bits are saved here, the number of bytes cannot be reduced. Therefore, the solution shown in FIG. 4 uses Tₛ as the unit. In this solution, the TA representation is not limited by the number of bits and is applicable to all NTN systems.

It should be noted here that, to remain consistent with the definition of timing advance in the existing TAR field (i.e., in units of slots), the data portion in milliseconds (ms, 1 ms=15*2048 Tₛ) in the solution shown in FIG. 4 can be adjusted to be in units of slots. This solution does not limit the specific dividing method of the timing advance amount N_{TA,UE-specific} estimated by the terminal device.

In embodiments of the present application, in addition to reporting the timing advance amount, the timing advance report may also include reporting the Doppler frequency shift. The network side can perform rough positioning of the terminal device based on the Doppler frequency shift and the timing advance amount. It should also be noted that the scope of the present application is not limited to the scenario examples described herein, nor does it limit how the network side uses the timing advance amount and Doppler frequency shift information.

The Doppler frequency shift is determined by the terminal device. Its specific determination process may refer to the prior art, which is not limited in the present application.

Specifically, the information unit further includes a third feature field including integer data of a Doppler frequency shift, and a fourth feature field including decimal data of the Doppler frequency shift.

In some embodiments of the present application, the information unit is transmitted in a multi-byte MAC CE format.

Two bytes of MAC CE are used to store the Doppler frequency shift.

Among them, the first two bits of one byte are reserved bits, the remaining bits of that byte are used to store the integer data of the Doppler frequency shift, and the other byte is used to store the decimal data of the Doppler frequency shift.

In a specific implementation, in a Low Earth Orbit satellite communication system, taking a satellite orbital altitude of 600 km as an example, the maximum Doppler frequency shift in the direction of satellite movement is generally less than 15 ppm. The Doppler frequency shift is reported to the base station side by adding two 8-bit bytes (i.e., 16 bits) to the Timing Advance Report MAC CE. As shown in FIG. 5, the first 2 bits of the third byte are reserved bits; the other 6 bits in the third byte represent the integer part of the Doppler frequency shift in ppm; the 8 bits of the fourth byte represent the decimal part of the Doppler frequency shift in ppm; the first 2 bits of the first byte are reserved bits; the 4 bits in the first byte represent the timing advance amount in milliseconds; and the remaining bits in the first byte and the second byte represent the remaining part of the timing advance amount in microseconds.

On the basis of the solution shown in FIG. 4, two 8-bit bytes are added for Doppler frequency shift reporting. The specific reporting format is as shown in FIG. 6. The first two bits of the first byte are reserved bits; the remaining bits of the first byte and the second byte represent the timing advance data in milliseconds; the third byte and the fourth byte are the remaining part of the timing advance amount in Tₛ; the first two bits of the fifth byte are reserved bits; the other 6 bits in the fifth byte represent the integer part of the Doppler frequency shift in ppm; and the 8 bits in the sixth byte represent the decimal part of the Doppler frequency shift in ppm.

In the solutions shown in FIGS. 5 and 6, the accuracy of the Doppler frequency shift is such that 8 bits are reserved for the decimal part. This is a specific embodiment. In a satellite communication system with a definite orbital altitude, the number of bits for the integer part can be appropriately reduced to further improve the accuracy.

It should be clarified that the present application does not limit the timing advance triggering and reporting mechanisms. For example, the existing TA reporting mechanism of 3GPP may be followed.

In embodiments of the present application, in order to enable the network side to obtain the timing advance value earlier, the timing advance amount estimated by the terminal device, or the timing advance amount and the frequency offset, may be reported to the network side in the first message transmitted by the terminal device during initial random access. There are two possible approaches:

(1) If the first message in the initial random access procedure is Msg1, a method similar to Msg3 carrying the TAR MAC CE may be adopted, where it is carried and transmitted to the network side by Msg1 together with the PRACH preamble sequence.

(2) If the first message in the initial random access procedure is MsgA, the timing advance value, or the timing advance value and the frequency offset, are transmitted to the network side as newly added content part of the PUSCH (Physical Uplink Shared Channel) in MsgA.

In existing NTN technologies, location-based mobility management, and uplink synchronization, etc., rely on the terminal device reporting its own GNSS-based location information. When the existing solution based on reporting terminal device location information may become unusable due to violations of personal privacy data regulations, or when GNSS is interfered with, the timing advance enhancement reporting method proposed in the present application enables the network side to obtain a higher-accuracy timing advance value, facilitating the network side to enhance GNSS operations in combination with beam footprint information.

Since the near-far effect is not significant in satellite communication systems, the conditions for the network side in terrestrial networks to determine cell coverage using signal strength and signal quality become inaccurate. As the satellite's movement trajectory and coverage area are determined, the method of determining cell coverage area using a distance (i.e., a high-accuracy timing advance value) is more accurate in the satellite communication system.

The first feature field, the second feature field, the third feature field, the fourth feature field, and the parameter field described in the present application are used to distinguish the timing advance amount, the Doppler frequency shift, and feature field data parameters (data dimension, data length, data format, etc.). During specific implementation, other names may also be given to the first feature field, the second feature field, the third feature field, the fourth feature field and the parameter field. For example, the parameter field in the present application may be named the first feature field, and the first, second, third, and fourth feature fields in the present application may be named the second, third, fourth, and fifth feature fields, respectively. Any solution that divides the timing advance amount into data of different dimensions and divides the Doppler frequency shift into integer and decimal parts falls within the protection scope of the present application.

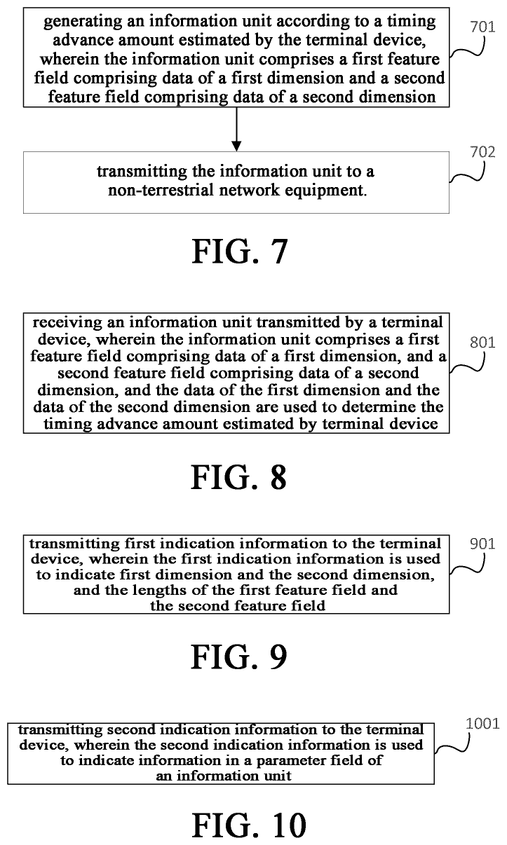

In embodiments of the present application, there is also provided a timing advance reporting method for a terminal device side. As illustrated in FIG. 7, the method includes the steps of:

701: generating an information unit according to a timing advance amount estimated by the terminal device, wherein the information unit includes a first feature field including data of a first dimension, and a second feature field including data of a second dimension; and

702: transmitting the information unit to a non-terrestrial network device, wherein accuracy of the first dimension is lower than accuracy of the second dimension.

The first dimension and the second dimension, and the lengths of the first feature field and the second feature field are configured by the non-terrestrial network device.

In embodiments of the present application, the information unit further includes a parameter field in which indication information is set, and the indication information is used to indicate the data dimension, data length, and data format of the feature field.

During specific implementation, the parameter field is configured by the non-terrestrial network device.

In embodiments of the present application, the first dimension is a millisecond, and the second dimension is a microsecond.

The first feature field at least includes 4 bits, and the second feature field at least includes 10 bits.

In embodiments of the present application, as illustrated in FIG. 3, the information unit is transmitted in a two-byte MAC CE format.

The first two bits of the first byte in the MAC CE are reserved bits, and the four bits following the reserved bits in the first byte in the MAC CE are used to store data of the first dimension, and the remaining bits in the MAC CE are used to store data of the second dimension.

In embodiments of the present application, the first dimension is a millisecond, and the second dimension is a basic time unit, such as Tₛ defined by 3GPP, i.e., 1/(15*2048) of a millisecond.

The first feature field at least includes 14 bits, and the second feature field at least includes 16 bits.

In embodiments of the present application, as illustrated in FIG. 4, the information unit is transmitted in a four-byte MAC CE format.

The first two bits of the first byte in the MAC CE are reserved bits, the remaining bits in the first byte and the second byte in the MAC CE are used to store data of the first dimension, and the third byte and the fourth byte in the MAC CE are used to store data of the second dimension.

In embodiments of the present application, the information unit further includes a first feature field, a second feature field, a third feature field, and a fourth feature field.

The first feature field includes data of a first dimension, the second feature field includes data of a second dimension, and the data of the first dimension and the data of the second dimension are determined according to the timing advance amount.

The third feature field includes integer data of a Doppler frequency shift, and the fourth feature field includes decimal data of the Doppler frequency shift.

In embodiments of the present application, as illustrated in FIG. 5, the information unit is transmitted in a four-byte MAC CE format.

The first two bits of the first byte in the MAC CE are reserved bits; the four bits following the reserved bits in the first byte of the MAC CE are used to store the data of the first dimension; the remaining bits of the first byte and the second byte in the MAC CE are used to store the data of the second dimension; the first two bits of the third byte in the MAC CE are reserved bits; the remaining bits of the third byte in the MAC CE are used to store integer data of a Doppler frequency shift; and the fourth byte in the MAC CE is used to store decimal data of the Doppler frequency shift. The splitting process of the integer data and the decimal data of the Doppler frequency shift may refer to the foregoing embodiments and will not be described in detail here.

In embodiments of the present application, as illustrated in FIG. 6, the information unit is transmitted in a six-byte MAC CE format.

The first two bits of the first byte in the MAC CE are reserved bits, the remaining bits of the first byte and the second byte in the MAC CE are used to store data of the first dimension (i.e., ms), the third byte and the fourth byte in the MAC CE are used to store data of the second dimension (Tₛ), the first two bits of the fifth byte in the MAC CE are reserved bits, the remaining bits of the fifth byte in the MAC CE are used to store integer data of a Doppler frequency shift, and the sixth byte in the MAC CE is used to store decimal data of the Doppler frequency shift.

The description of the present application provides four feasible solutions in FIGS. 3 to 6, and the FIGS. 3 to 6 are denoted as Solution One, Solution Two, Solution Three and Solution Four, respectively. In the actual system disclosure, Solutions One and Two, or Solutions Two and Four can be selected according to specific requirements. The present application does not require all feasible solutions to be used simultaneously. In addition, FIGS. 3 to 6 merely illustrate some specific embodiments. Those skilled in the art may obtain embodiments not limited to FIGS. 3 to 6 during implementation.

In embodiments of the present application, transmitting the information unit to a non-terrestrial network device in the aforementioned step 702 includes first transmitting the information unit to the non-terrestrial network device when the terminal device performs initial random access.

In embodiments of the present application, there is further provided a timing advance reporting method applied to a non-terrestrial network device. As illustrated in FIG. 8, the method includes the steps of:

Step 801: receiving an information unit transmitted by a terminal device, wherein the information unit includes a first feature field including data of a first dimension, and a second feature field including data of a second dimension, and the data of the first dimension and the data of the second dimension are used to determine the timing advance amount estimated by the terminal device.

In some embodiments, the information unit further includes a third feature field including integer data of the Doppler frequency shift, and a fourth feature field including decimal data of the Doppler frequency shift. During specific implementation, the information unit is formed in an order of the first feature field, the second feature field, the third feature field and the fourth feature field.

In embodiments of the present application, as illustrated in FIG. 9, the timing advance reporting method applied to the non-terrestrial network device further includes the steps of:

Step 901: transmitting first indication information to the terminal device, wherein the first indication information is used to indicate first dimension and the second dimension, and the lengths of the first feature field and the second feature field.

In embodiments of the present application, as illustrated in FIG. 10, the timing advance reporting method applied to the non-terrestrial network device further includes the steps of:

Step 1001: transmitting second indication information to the terminal device, wherein the second indication information is used to indicate information in a parameter field of an information unit.

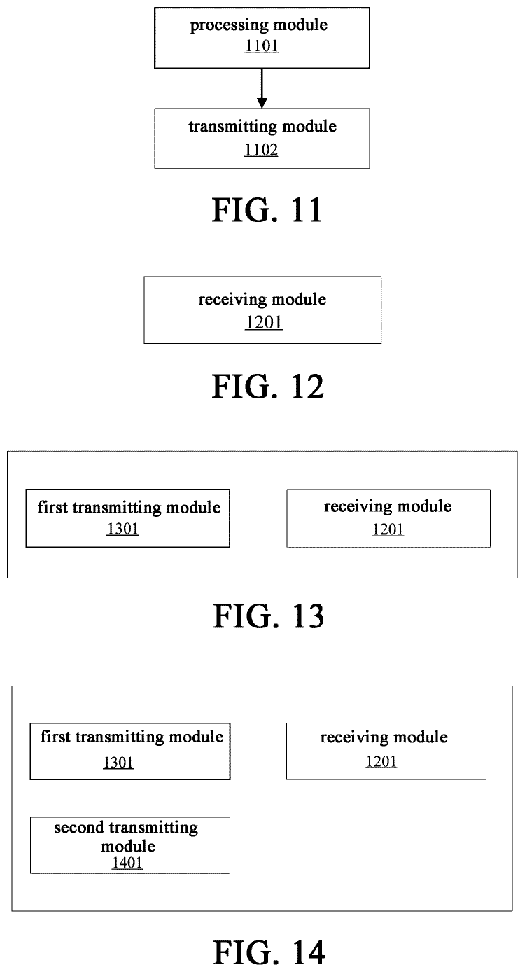

In embodiments of the present application, as illustrated in FIG. 11, there is further provided a timing advance reporting apparatus for a terminal device, including:

a processing module 1101 configured to generate an information unit according to a timing advance amount estimated by the terminal device, wherein the information unit includes a first feature field including data of a first dimension, and a second feature field including data of a second dimension; and

a transmitting module 1102 configured to transmit the information unit to a non-terrestrial network device. During specific implementation, the transmitting module first transmits the information unit to the non-terrestrial network device when the terminal device performs initial random access.

Herein, accuracy of the first dimension is lower than accuracy of the second dimension.

The first dimension and the second dimension, and the lengths of the first feature field and the second feature field are configured by the non-terrestrial network device.

In embodiments of the present application, the information unit further includes a parameter field in which indication information is set, and the indication information is used to indicate data dimension, data length, and data format of the feature fields. The data length of the parameter field depends on the number of the timing advance amount and/or Doppler frequency shift reporting solutions. During implementation, the parameter field is configured by the non-terrestrial network device and can be pre-agreed according to a protocol.

In embodiments of the present application, the first dimension is a millisecond, and the second dimension is a microsecond.

The first feature field at least includes 4 bits, and the second feature field at least includes 10 bits.

As illustrated in FIG. 3, the information unit is transmitted in a two-byte MAC CE format.

The first two bits of the first byte in the MAC CE are reserved bits, the four bits following the reserved bits in the first byte in the MAC CE are used to store data of the first dimension, and the remaining bits in the MAC CE are used to store data of the second dimension.

In embodiments of the present application, the first dimension is a millisecond, and the second dimension is a basic time unit defined by 3GPP.

The first feature field at least includes 14 bits, and the second feature field at least includes 16 bits.

As illustrated in FIG. 4, the information unit is transmitted in a four-byte MAC CE format.

The first two bits of the first byte in the MAC CE are reserved bits, the remaining bits in the first byte and the second byte in the MAC CE are used to store data of the first dimension, and the third byte and the fourth byte in the MAC CE are used to store data of the second dimension.

In embodiments of the present application, the information unit includes a first feature field, a second feature field, a third feature field, and a fourth feature field. The first feature field includes data of a first dimension, the second feature field includes data of a second dimension, and the data of the first dimension and the data of the second dimension are determined by the timing advance amount. The third feature field includes integer data of a Doppler frequency shift, and the fourth feature field includes decimal data of the Doppler frequency shift.

In some embodiments, as illustrated in FIG. 5, the information unit is transmitted in a four-byte MAC CE format. The first two bits of the first byte in the MAC CE are reserved bits, the four bits following the reserved bits in the first byte in the MAC CE are used to store data of the first dimension, the remaining bits of the first byte and the second byte in the MAC CE are used to store data of the second dimension, the first two bits of the third byte in the MAC CE are reserved bits, the remaining bits of the third byte in the MAC CE are used to store integer data of a Doppler frequency shift, and the fourth byte in the MAC CE is used to store decimal data of the Doppler frequency shift.

In some embodiments, as illustrated in FIG. 6, the information unit is transmitted in a six-byte MAC CE format.

The first two bits of the first byte in the MAC CE are reserved bits, the remaining bits of the first byte and the second byte in the MAC CE are used to store data of the first dimension (i.e., ms), the third byte and the fourth byte in the MAC CE are used to store data of the second dimension (Tₛ), the first two bits of the fifth byte in the MAC CE are reserved bits, the remaining bits of the fifth byte in the MAC CE are used to store integer data of a Doppler frequency shift, and the sixth byte in the MAC CE is used to store decimal data of the Doppler frequency shift.

In embodiments of the present application, there is further provided a timing advance reporting apparatus for a non-terrestrial network device. As illustrated in FIG. 12, the apparatus includes:

a receiving module 1201 configured to receive an information unit transmitted by a terminal device, wherein the information unit includes a first feature field including data of a first dimension, and a second feature field including data of a second dimension, and the data of the first dimension and the data of the second dimension are used to determine a timing advance amount estimated by the terminal device.

In some embodiments, the information unit further includes a third feature field including integer data of the Doppler frequency shift, and a fourth feature field including decimal data of the Doppler frequency shift. During specific implementation, the information unit is formed in an order of the first feature field, the second feature field, the third feature field and the fourth feature field.

In embodiments of the present application, as illustrated in FIG. 13, the timing advance reporting apparatus for the non-terrestrial network device side further includes:

a first transmitting module 1301 configured to transmit first indication information to the terminal device, wherein the first indication information is used to indicate first dimension and the second dimension, and the lengths of the first feature field and the second feature field.

In embodiments of the present application, as illustrated in FIG. 14, the timing advance reporting apparatus for the non-terrestrial network device side further includes:

a second transmitting module 1401 configured to transmit second indication information to the terminal device, wherein the second indication information is used to indicate information in a parameter field of an information unit.

Based on the above embodiments, after obtaining the timing advance amount N_{TA,UE-specific} and the Doppler frequency shift estimated by the terminal device, the non-terrestrial network device further calculates a total timing advance amount according to N_{TA}, N_{TA,common}, N_{TA,offset} and N_{TA,UE-specific}; determines location information of the terminal device according to the total timing advance amount and the Doppler frequency shift; and optimizes beam pointing based on the location information of the terminal device.

Determining the location information of the terminal device by the network device according to the total timing advance amount and the Doppler frequency shift includes: determining a transmission delay according to the total timing advance amount; calculating a first pitch angle from the terminal device to the sub-satellite point via the satellite according to the transmission delay and the orbital altitude of the satellite; calculating a first azimuth angle from the satellite's movement direction when viewed from the satellite top view to the terminal device via sub-satellite point according to the first pitch angle, the Doppler frequency shift, a satellite carrier frequency, and a satellite movement speed; and determining the location information of the terminal device according to the first pitch angle and the first azimuth angle.

Specifically, the first pitch angle is calculated in formula:

$${θ}_{0} = arccos ( S O / ( {τ}_{0} \cdot c ) ) ;$$

where θ₀ is the first pitch angle, SO is the orbital altitude of the satellite, τ₀ is the transmission delay, and c is the speed of light.

The candidate angles are calculated in formulas:

$${φ}_{01} = π - arccos ( \frac{( {f}_{o} / {f}_{c} ) \cdot c}{v \cdot sin {θ}_{0}} ) ; {φ}_{02} = π + arccos ( \frac{( {f}_{o} / {f}_{c} ) \cdot c}{v \cdot sin {θ}_{0}} )$$

where φ₀₁ is a first candidate angle, φ₀₂ is a second candidate angle, fₒ is the Doppler frequency shift, f_{c} is the satellite carrier frequency, c is the speed of light, v is the satellite movement speed, and θ₀ is the first pitch angle.

Determining the first azimuth angle from the first candidate angle and the second candidate angle according to information on beam footprint where the terminal device is located specifically includes: determining, from information on beam footprint where the terminal device is located, a second azimuth angle from the satellite movement direction when viewed from the satellite top view to the beam center point via the sub-satellite point; calculating a difference value between the first candidate angle and the second azimuth angle and a difference value between the second candidate angle and the second azimuth angle, respectively; and selecting the candidate angle corresponding to the smallest difference value as the first azimuth angle.

This embodiment enables the satellite network device to automatically estimate the location information of the terminal device, thereby ensuring service continuity for a communication system architecture that heavily relies on terminal location information, and avoiding situations where the network side cannot determine the terminal device's location because the terminal fails to report its own location information to the network side in a timely manner, while protecting the user privacy.

Further, the non-terrestrial network device is also configured to perform the following operations: determine a second pitch angle from the beam center to the sub-satellite point via the satellite according to the information on beam footprint where the terminal device is located; calculate a difference value between the first pitch angle and the second pitch angle; if the difference value is greater than a preset value, determine that the location information of the terminal device is invalid; if the difference value is less than or equal to the preset value, determine that the location information of the terminal device is valid. After the location information of the terminal device is determined to be valid, the beam pointing is optimized according to the location information of the terminal device. After the location information of the terminal device is determined to be invalid, the beam pointing is determined using the information on beam footprint where the terminal device is located.

Based on the above embodiments, after obtaining information such as the high-accuracy timing advance amount and the angle between the beam and the satellite's movement direction (also referred to as the azimuth angle based on the satellite's movement direction), the non-terrestrial network device can also determine whether the terminal device is at an edge beam footprint without relying on the terminal device's location information when it is unknown, and then perform some necessary optimization designs at the system or network side for terminals at the edge beam footprint.

Based on the above embodiments, the non-terrestrial network device optimizes beam pointing for a single terminal device or multiple terminal devices according to the high-accuracy timing advance amount estimated by the terminal device and the TA information from the satellite to the center point of the beam footprint where the terminal device is located.

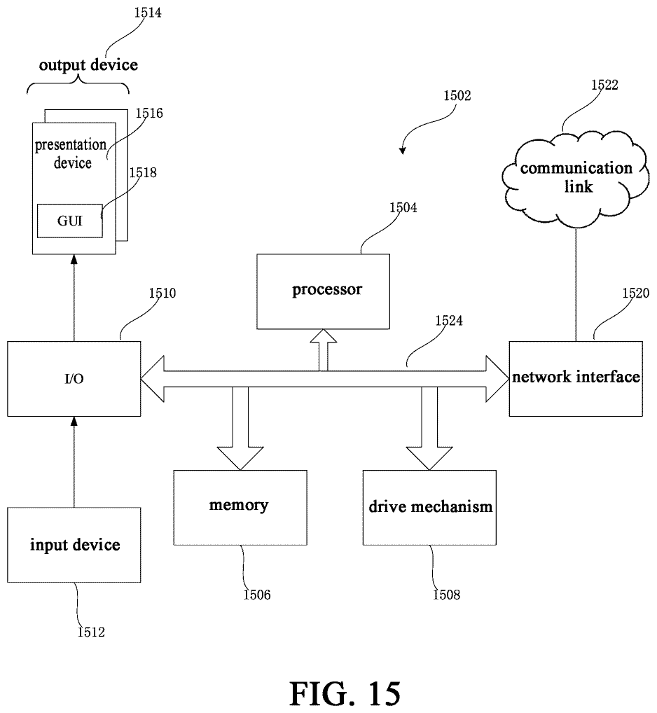

In embodiments of the present application, there is also provided a terminal device. As illustrated in FIG. 15, a terminal device 1502 may include one or more processors 1504, such as one or more central processing modules (CPUs), and each processing module may implement one or more hardware threads. The terminal device 1502 may also include any memory 1506 for storing any type of information such as code, settings, data, or the like. For example, the memory 1506 may include any one of or a combination of any type of RAM, any type of ROM, flash memory devices, hard disks, optical disks, or the like, without limitation. More generally, any memory can use any technology to store information. Further, any memory may provide volatile or non-volatile retention of information. Furthermore, any memory may represent a fixed or removable component of the terminal device 1502. In one case, when the processor 1504 executes associated instructions stored in any of the memories or a combination of memories, the terminal device 1502 may perform any operation of the associated instructions. The terminal device 1502 also includes one or more drive mechanisms 1508 configured to interact with any memory, such as a hard disk drive mechanism, an optical disk drive mechanism, or the like.

The terminal device 1502 may also include an input/output module 1510 (I/O) for receiving inputs (via an input device 1512) and for providing outputs (via an output device 1514). One specific output mechanism may include a presentation device 1516 and an associated graphical user interface 1518 (GUI). In other embodiments, the input/output module 1510 (I/O), the input device 1512, and the output device 1514 may not be included, and may only serve as one terminal device in the network. The terminal device 1502 may also include one or more network interfaces 1520 for exchanging data with other devices via one or more communication links 1522. One or more communication buses 1524 couple together the components described above.

The communication links 1522 may be implemented in any manner, for example, through a local area network, a wide area network (e.g., the Internet), a point-to-point connection, or any combination thereof. The communication links 1522 may include any combination of hardwired links, wireless links, routers, gateway functions, name servers governed by any protocol or a combination of protocols.

The embodiments of the present application also provide a computer-readable storage medium storing a computer program that, when executed by a processor, implements the steps of the method.

The embodiments of the present application also provide a computer-readable instruction, wherein when a processor executes the instruction, the program therein enables the processor to perform the method according to any of the preceding embodiments.

It should be understood that in the embodiments of the present application, a size of sequence numbers of the processes does not mean an order of execution. The order of execution of the processes should be determined by its function and inherent logic, and should not constitute any limitation on the implementation process of the embodiments of the present application.

It should also be understood that in the embodiments of the present application, the term “and/or” only refers to an association relationship that describes associated objects, and indicates that three relationships may exist. For example, A and/or B can represent three situations: A exists alone, both A and B exist, and B exists alone. In addition, the character “/” in the present application generally means that the associated objects have an “or” relationship.

Those skilled in the art may realize that the units and algorithm steps of each example described in combination with the embodiments contained in the present application can be implemented in electronic hardware, computer software, or a combination thereof. In order to clearly demonstrate the interchangeability of hardware and software, the components and steps of each example have been generally described in terms of functions in the above description. Whether these functions are performed in hardware or software depends on specific disclosures and design constraints of the technical solution. Those skilled in the art may adopt different methods to achieve the described functions for each particular disclosure, however, such implementation should not be considered beyond the scope of the present application.

Those skilled in the art can readily understand that for the sake of convenience and brevity in description, the corresponding processes in the preceding method embodiments can be referred to for the specific working processes of the system, device and units described above, and will not be described again here.

It should be understood that the disclosed system, device and method may be implemented in other ways in the embodiments provided in the present application. For example, the device embodiments described above are only illustrative. For example, a division of the units only refers to a division of logical functions. Other division methods may exist in actual implementation. For example, a plurality of units or components may be combined or integrated into another system, or some features may be ignored or not implemented. In addition, the coupling or direct coupling or communication connection to each other shown or discussed may be indirect coupling or communication connection through some interfaces, devices or units, or may be electrical, mechanical or other forms of connection.

The units described as separate components may or may not be physically separated, and the components displayed as units may or may not be physical units, that is, the components may be located in one place, or the components may be distributed to a plurality of network units. Some or all of the units can be selected according to actual needs to achieve the objectives of the solutions of the embodiments of the present application.

In addition, each functional unit in the embodiments of the present application may be integrated into one processing unit, each unit may physically exist separately, or two or more units may be integrated into one unit. The integrated units can be implemented in the form of hardware or in the form of software functional units.

The integrated units can be stored in a computer-readable storage medium when implemented in the form of software functional units and sold or used as an independent product. Based on this understanding, the technical solution of the present application essentially or the part making contributions to the prior art, or all or part of the technical solution may be embodied in the form of a software product. The computer software product is stored in a storage medium and includes a plurality of instructions to enable a computer device (which may be a personal computer, a server, a network device) to perform all or part of steps of the method according to the embodiments of the present application. And the aforementioned storage medium includes media that can store program codes such as USB flash drives, portable hard disks, Read-Only Memory (ROM), Random Access Memory (RAM), magnetic disks or optical disks.

Specific embodiments are used in the present application to demonstrate the principle and implementation of the present application. The description of the embodiments is solely used to aid in understanding the method and core concept of the present application; meanwhile, modifications may be made to the specific embodiments and scope of disclosure for those skilled in the art based on the concept of the present application. In summary, the contents of this specification should not be construed as limitations on the present application.

1. A timing advance reporting apparatus for a terminal device, wherein the timing advance reporting apparatus comprises:
a processor; and
a memory configured to store instructions executable by the processor,
wherein the processor is configured to:
generate an information unit according to a timing advance amount estimated by the terminal device, wherein the information unit comprises a first feature field comprising data of a first dimension and a second feature field comprising data of a second dimension; and
transmit the information unit to a non-terrestrial network device.

2. The timing advance reporting apparatus according to claim 1, wherein accuracy of the first dimension is lower than accuracy of the second dimension.

3. The timing advance reporting apparatus according to claim 2, wherein the first dimension is a millisecond and the second dimension is a microsecond.

4. The timing advance reporting apparatus according to claim 3, wherein the information unit is carried in two bytes.

5. The timing advance reporting apparatus according to claim 2, wherein the first dimension is a millisecond, and the second dimension is 1/(15*2048) of a millisecond.

6. The timing advance reporting apparatus according to claim 5, wherein the information unit is carried in four bytes.

7. The timing advance reporting apparatus according to claim 1, wherein the information unit further comprises a parameter field containing indication information, and the indication information is used to indicate a data format of a feature field.

8. The timing advance reporting apparatus according to claim 7, wherein the data format comprises a data dimension and a data length.

9. The timing advance reporting apparatus according to claim 1, wherein the information unit further comprises a third feature field comprising integer data of a Doppler frequency shift, and a fourth feature field comprising decimal data of the Doppler frequency shift.

10. A timing advance reporting method for a terminal device, comprising:
generating an information unit according to a timing advance amount estimated by the terminal device, wherein the information unit comprises a first feature field comprising data of a first dimension and a second feature field comprising data of a second dimension; and
transmitting the information unit to a non-terrestrial network device.

11. The timing advance reporting method according to claim 10, wherein accuracy of the first dimension is lower than accuracy of the second dimension.

12. The timing advance reporting method according to claim 11, wherein the first dimension is a millisecond and the second dimension is a microsecond.

13. The timing advance reporting method according to claim 12, wherein the information unit is carried in two bytes.

14. The timing advance reporting method according to claim 11, wherein the first dimension is a millisecond, and the second dimension is 1/(15*2048) of a millisecond.

15. The timing advance reporting method according to claim 14, wherein the information unit is carried in four bytes.

16. The timing advance reporting method according to claim 10, wherein the information unit further comprises a parameter field in which indication information is set, and the indication information is used to indicate a data format of a feature field.

17. The timing advance reporting method according to claim 16, wherein the data format comprises a data dimension and a data length.

18. The timing advance reporting method according to claim 10, wherein the information unit further comprises a third feature field comprising integer data of a Doppler frequency shift, and a fourth feature field comprising decimal data of the Doppler frequency shift.

19. A non-transitory computer-readable storage medium having stored therein instructions that, when executed by a processor, causes the processor to perform a timing advance reporting method for a terminal device, comprising:
generating an information unit according to a timing advance amount estimated by the terminal device, wherein the information unit comprises a first feature field comprising data of a first dimension and a second feature field comprising data of a second dimension; and
transmitting the information unit to a non-terrestrial network device.

20. The non-transitory computer-readable storage medium according to claim 19, wherein accuracy of the first dimension is lower than accuracy of the second dimension.
